(19) United States
(12) Patent Application Publication
(10) Pub. No.: US 2002/0159253 A1
(43) Pub. Date: Oct. 31, 2002

(54) Attachable illumination device

(76) Inventors: William T. Dalebout, North, Logan, UT (US); Jaremy T. Butler, Paradise, UT (US)

Correspondence Address: David B. Dellenbach, WORKMAN, NYDEGGER & SEELEY, 1000 Eagle Gate Tower, 60 East South Temple, Salt Lake City, UT, 84111, US

(21) Appl. No.: 09/843,531

(22) Filed: Apr. 26, 2001

(51) Int. Cl. F21L 4/00

(52) U.S. Cl. 362/191; 362/102; 362/396

(57) ABSTRACT

A flashlight housing and bracket system that is selectively and removably coupled to a support member of a non-motorized recreational vehicle or another structure. The system includes a light source that is selectively actuated or deactuated by a user and a flashlight housing that houses a light source and a power source. The housing includes two portions that couple a bracket system having gripping fingers to a support member. The rotation of a first portion of the housing with respect to the second portion selectively actuates or deactuates the light source depending on the direction of the rotation.

### BACKGROUND OF THE INVENTION

1. The Field of the Invention

The present invention relates to an attachable illumination device. More specifically, the present invention is directed to a flashlight housing and bracket system that is selectively and removably coupled to a support member of a non-motorized recreational vehicle or other structure, such as a scooter.

2. Background and Related Art

Various non-motorized recreational vehicles have been manufactured for individuals to ride thereon. Such vehicles include tricycles, bicycles, scooters and wagons, and may be ridden on public streets, public sidewalks, driveways, parking lots, and other such surfaces. Reflectors have been designed and manufactured for mounting onto the non-motorized recreational vehicles in order to increase their visibility by drivers of motorized vehicles, such as cars, trucks, buses, and motorcycles. The mountable reflectors generally include a material such as glass, plastic, or metal that reflects light. Therefore, for example, as the headlights of an automobile shine on a reflector mounted onto a recreational vehicle, the illumination from the headlights is reflected back from the reflector to inform the automobile driver of the presence of the recreational vehicle.

While the use of a reflector informs motorized vehicle drivers of the presence of a non-motorized recreational vehicle, a light source in front of the recreational vehicle has proven to be beneficial to the individual riding the recreational vehicle after dusk. For example, in an attempt to provide illumination in front of a bicycle in order to ride the bike after dusk, riders have mounted a light to the bicycle. The light may be secured onto the handlebars of the bicycle, for example, to continually provide illumination in the forward path of the bicycle. As such, the illumination provided allows the individual riding the bicycle to see and avoid obstacles that are in the forward path of the bicycle.

Various clamps have been manufactured that allow a light to be secured onto a non-motorized recreational vehicle, such as onto the handlebars of a bicycle. The clamps include screws, bolts, nuts, and other hardware fasteners for securing the clamps onto the recreational device. However, the requirement of hardware fasteners and one or more tools, such as screwdrivers, pliers, and wrenches, causes the process of securing and/or adjusting a standard light onto a non-motorized recreational vehicle to be difficult, especially for young children who ride the recreational vehicles.

### SUMMARY OF THE INVENTION

The present invention relates to an attachable illumination device. More specifically, the present invention is directed to a flashlight that is selectively and removably coupled to a support member of a non-motorized recreational vehicle or other structure.

Implementation of the present invention includes a power source electrically coupled to a light source. The light source may be selectively actuated or deactuated by a user. In one embodiment, a flashlight housing houses the power source and includes two portions that are threadedly coupled to each other. A bracket system includes cylindrical coupling rings for coupling the bracket system to the flashlight housing and gripping fingers extending from the coupling rings to mount the bracket system to a support member when the flashlight housing is coupled. By rotating a first portion of the flashlight housing with respect to a second portion, the light source is selectively actuated to provide illumination or deactuated to provide no illumination. Furthermore, rotating the first and second portions of the flashlight housing toward each other pushes the two-part bracket together, causing the gripping fingers of the bracket system to mount onto a support member, such as the handlebars of a scooter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a perspective view of an exemplary embodiment of the present invention;

FIG. 2 illustrates a perspective view of the exemplary embodiment of FIG. 1 selectively and removably coupled onto a support member of a scooter;

FIG. 3A illustrates an exploded view of the exemplary embodiment of FIG. 1;

FIG. 3B illustrates a back planar view of the female end of the head module, as provided in FIG. 3A;

FIG. 4A illustrates a schematic representation of an exemplary electrical circuit that may be associated with the embodiment of FIG. 1, wherein the exemplary electrical circuit is in an open position; and

FIG. 4B illustrates the exemplary electrical circuit of FIG. 4A in a closed position.

### DETAILED DESCRIPTION OF THE INVENTION

The present invention relates to an attachable illumination device. More specifically, the present invention is directed to a flashlight housing and bracket system that is selectively and removably coupled to a support member of a non-motorized recreational vehicle, such as a scooter, or other structure.

In this disclosure, reference is made to a light source that provides illumination. In this disclosure and in the appended claims the term “light source” refers to any component or device that is capable of emitting light, including a light bulb, a light emitting diode (“LED”), laser, etc., each of which being an example of means for providing illumination. A reflector, such as a parabolic reflector, may be employed about the light source to concentrate the illumination of the light source into a beam of light.

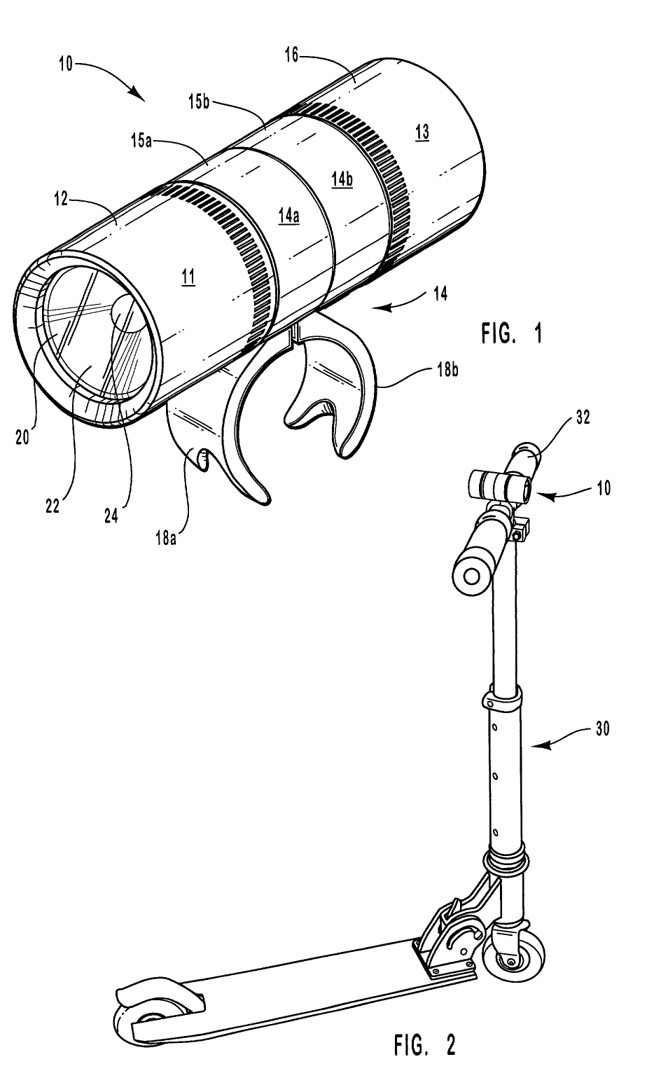

While the embodiments illustrated in FIGS. 1-4B correspond to a flashlight that is selectively and removably coupled to a handlebar of a scooter (illustrated in FIG. 2), embodiments of the present invention embrace illumination devices that that may be selectively and removably coupled to a variety of different support members of various structures. Also, the embodiments of the present invention embrace a variety of different shapes and sizes, a variety of different electrical circuits, and/or a variety of different components to implement the features of the present invention.

With reference to FIG. 1, a perspective view is illustrated of an exemplary embodiment of the present invention, illustrated as flashlight 10. Flashlight 10 comprises a housing, which may house a power source, one or more light sources, and a variety of other components as desired. For purposes of this disclosure and in the claims, the term “housing” shall refer to a structure that houses at least a portion of one or more components of the flashlight therein or thereon. The housing of flashlight 10 is preferably comprised of two threadedly and selectively coupled housing portions, namely housing portions 11 and 13 that house selected components. Each housing portion is part of a module. Housing portion 11 is part of head module 12 and housing portion 13 is part of body module 16. Housing portions 11 and 13 collectively serve as an example of a flashlight housing that houses a power source and at least one light source electrically coupled thereto. A bracket system 14 is interposed between a surface of housing portion 11 and a surface of housing portion 13 to couple the bracket system 14 to a support member, as will be further explained below.

In the illustrated embodiment, the first housing portion 11 and second housing portion 13 comprise a conductive material, such as metal. In a further embodiment, the first housing portion 11 and second housing portion 13 comprise aircraft-grade aluminum. Other embodiments of the present invention embrace housing portions that comprise a non-conductive material, such as plastic. When the housing comprises a non-conductive material, modifications may be required to the electrical circuit to make the circuit completely internal in relation to the non-conductive housing, as will be appreciated by those skilled in the art and are embraced by embodiments of the present invention.

As illustrated in FIG. 1, flashlight 10 further comprises head module 12 and body module 16. Head module 12 comprises a light source 24 that may be selectively actuated to provide illumination. As provided above, the light source may be any component or device that is capable of emitting light, such as a light bulb, an LED, a laser, etc. Head module 12 further comprises a reflector 22 that is positioned about the light source 24 so as to assist in concentrating, focusing and/or directing the illumination into a generally linear beam of light through a lens 22. Reflector 22 may comprise a variety of materials that may be used in projecting a direct beam of light in a generally linear direction. In one embodiment, the reflector is a parabolic reflector to maximize the concentration of the light from the light source.

Lens 22 may comprise any transparent or semi-transparent material, such as glass, plastic, etc., to allow a beam of light to shine therethrough. In one embodiment, lens 22 is a polycarbonate lens that is shatterproof and scratch resistant. Furthermore, the polycarbonate lens provides optical clarity for a pure lighted view. While the illustrated embodiment comprises a single light source 24 that provides the illumination that is focused into a beam of light, embodiments of the present invention embrace the utilization of a plurality of light sources for providing the illumination, as will be appreciated by those skilled in the art.

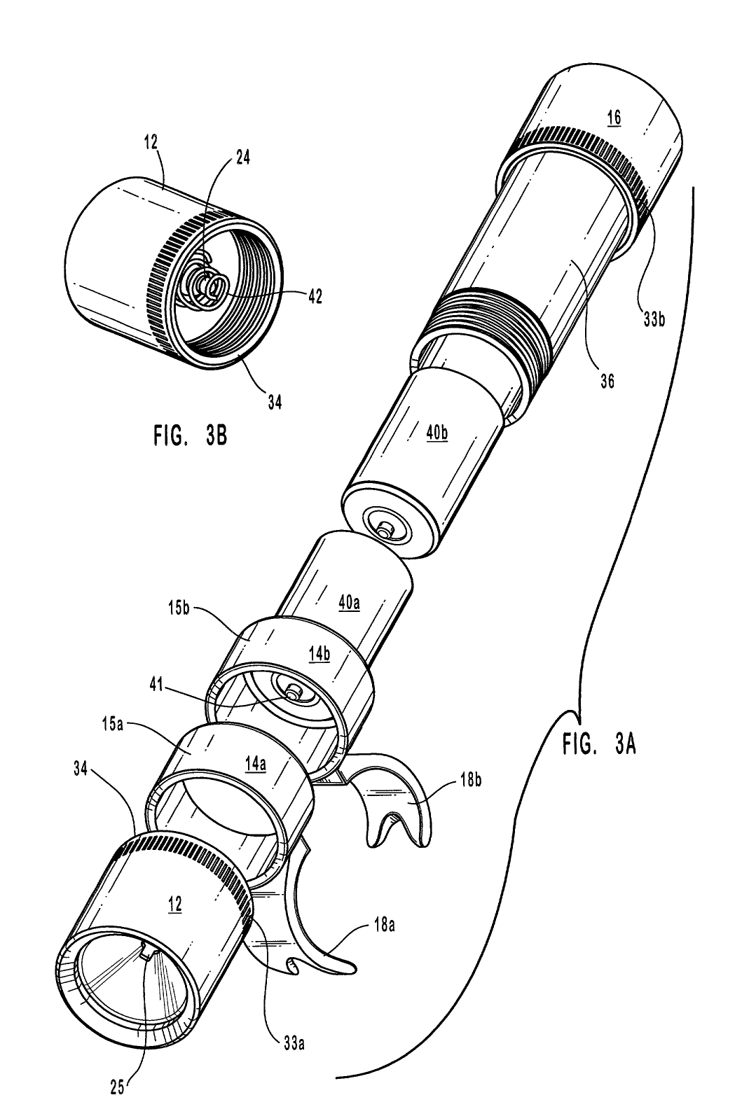

In the illustrated embodiment, head module 12 and body module 16 are threadedly coupled and enable a light source to be electrically coupled to a power source to provide illumination, as will be further explained below. In the illustrated embodiment, body module 16 has a threaded male end (illustrated as male end 36 in FIG. 3A) that is threadedly coupled to a female end of head module 12 (illustrated as female end 34 of FIG. 3B).

Bracket system 14 comprises a first bracket portion 14a and a second bracket portion 14b. The first bracket portion 14a includes a cylindrical coupling ring 15a and a gripping finger 18a extending therefrom. Likewise, the second bracket portion 14b includes a cylindrical coupling ring 15b and a gripping finger 18b extending therefrom. The two bracket portions 14a and 14b are mirror images of each other and reside about the male end of body module 16 when head module 12 and body module 16 are coupled. Gripping fingers 18a and 18b are designed to securely hold the flashlight 10 coupled onto a support member when bracket system 14 is tightly held together by head module 12 and body module 16.

Cylindrical coupling rings 15a and 15b are collectively an example of a coupling portion of a bracket system, wherein the bracket system is configured to selectively and removably couple a flashlight to a support member. Furthermore, gripping fingers 18a and 18b are collectively an example of a gripping portion extending from the coupling portion. The bracket system is configured such that the coupling of a flashlight housing to the coupling portion couples the gripping portion to the support member.

In the illustrated embodiment, bracket system 14 comprises a non-conductive material, such as plastic. Other embodiments embrace bracket systems that comprise a conductive material, such as metal, and/or a different shape.

The light source 24 of head module 12 is actuated or deactuated by a user rotating head module 12 with respect to body module 16. Light source 24 is actuated as an internal spring (illustrated as spring 42 of FIG. 3B) closes the electrical circuit in response to a user rotating the head module 12 in a first direction in relation to body module 16. Similarly, light source 24 is deactuated when the electrical circuit is opened in response to a user rotating the head module 12 in a second opposite direction with respect to the body module 16. As will be appreciated by those of skill in the art, embodiments of the present invention embrace a variety of other manners and/or devices for actuating and/or deactuating a light source, including using a variety of different switches or buttons that may be employed by a user.

With reference now to FIG. 2, a perspective view is provided of a flashlight 10 selectively and removably coupled to a support member of a non-motorized recreational vehicle. In FIG. 2, the non-motorized recreational vehicle illustrated is a scooter 30 and the support member is a handlebar 32. While FIG. 2 illustrates flashlight 10 coupled to a scooter, embodiments of the present invention may be removably coupled to a variety of devices, such as bicycles, tricycles, trailers, beams, poles, tables, tents, backpacks, head gear, various other types of camping, recreational hiking, scientific and medical equipment, motorized scooters, automobiles and other structures.

When head module 12 and body module 16 are loosely coupled together and bracket system 14 is interposed between a surface of head module 12 and a surface of body module 16, gripping fingers 18a and 18b may receive a support structure, such as handlebars 32 of FIG. 2. Once gripping fingers 18 are placed about handlebar 32, head module 12 and body module 16 may be threaded more closely together, thereby pushing the bracket portions 14a and 14b of bracket system 14 together. When firmly together, head module 12 and body module 16 hold gripping fingers 18 about handlebar 32. In one embodiment, the inner surfaces of respective gripping fingers 18, which contact handlebar 32, comprise a grip to facilitate holding onto handlebars 32.

Therefore, rather than using one or more fasteners to secure a flashlight, embodiments of the present invention utilize a flashlight that holds gripping fingers about a support member. Embodiments of the present invention require no tools for attaching or fastening the flashlight. Instead, head module 12 and body module 16 are simply threadedly coupled such that the male end of body module 16 is coupled to the female end of head module 12, thereby pushing bracket system 14 together. As such, a child who would be riding the scooter, for example, is able to quickly and easily couple, adjust, and/or decouple flashlight 10 from scooter 30.

With reference now to FIGS. 3A and 3B, an exploded view is provided of the exemplary embodiment of FIG. 1. Head module 12 comprises a first housing portion, a lens, a reflector, and a light source. In FIG. 3A, light source 25 is a high intensity light source compared to light source 24 of FIG. 1. As provided above, the light source may be any component or device that is capable of emitting light, such as a light bulb, an LED, a laser, etc. Head module 12 has a female end 34 having internal threads that may be coupled to external threads of male end 36 of body module 16. Further, the illustrated embodiment comprises a grip 33a and 33b respectively illustrated on head module 12 and body module 16. The grip 33 facilitates rotating head module 12 with respect to body module 16.

While FIG. 3A illustrates head module 12 as being capable of being threadedly coupled to body module 16, other manners exist to couple head module 12 to body module 16, such as by clipping, snapping, screwing, friction fit, bonding, etc., as will be appreciated by those skilled in the art in light of this disclosure. Thus, threads, clips, snap fitting parts, friction fitting parts, and other connection parts are examples of coupling portions configured to couple a first portion of a flashlight housing to a second portion of the housing.

Bracket system 14 resides about male end 36 of body module 16 and a power source is generally contained within body module 16. In the illustrated embodiment, the power source used to illuminate the light source in head module 12 is a series of batteries 40 that reside in body module 16 when head module 12 and body module 16 are coupled. While FIG. 3A illustrates two batteries, namely batteries 40a and 40b, embodiments of the present invention embrace the use of one battery, more than two batteries, or another power source, such as a solar cell, or a mechanism that uses a moving tire or wheel to generate electrical power.

With reference to FIG. 3B, a back view of head module 12 is provided to illustrate female end 34. In FIG. 3B an internal spring 42 is electrically coupled to a contact of the light source. When the positive end 41 of batteries 40 is in electrical contact with spring 42, the electrical circuit is closed to thereby actuate the light source in head module 12. The process of actuating or deactuating the light source in head module 12 is performed by rotating head module 12 with respect to body module 16.

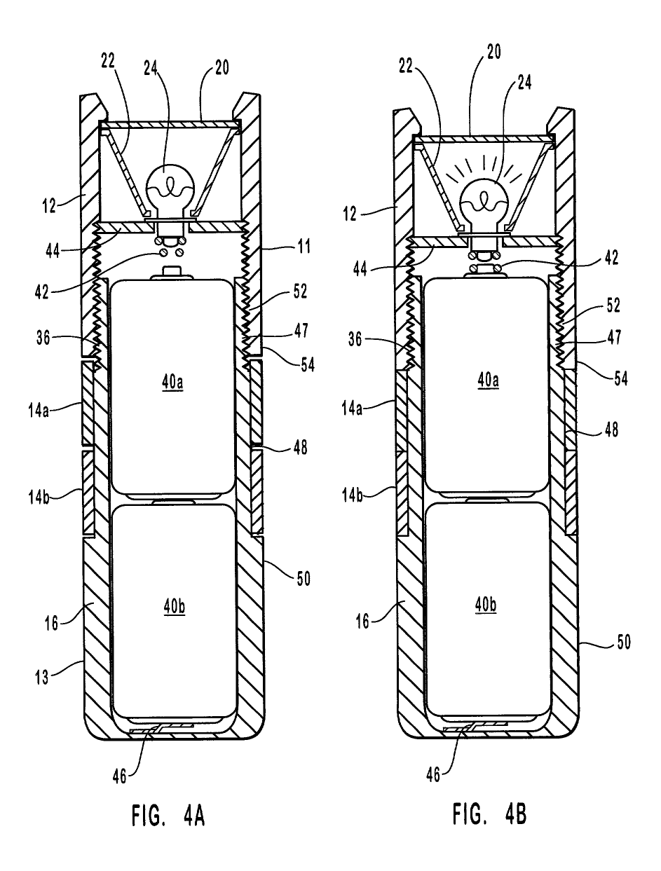

With reference now to FIGS. 4A and 4B, a schematic representation is provided of the exemplary embodiment of FIG. 1. FIG. 4A provides an open circuit in which light source 24 in head module 12 is deactivated and FIG. 4B provides a closed circuit in which light source 24 in head module 12 is actuated so as to provide illumination. While FIGS. 4A and 4B and the corresponding discussion are intended to provide a brief, general description of an exemplary schematic representation of an electrical circuit that is used to provide features of the present invention, those skilled in the art will appreciate that the invention may be practiced using a variety of different components and/or circuit configurations to implement features of the present invention.

In FIG. 4A a schematic representation is provided of an open circuit and a deactuated light source 24. As illustrated, light source 24 is electrically connected to a conductive plate 44, which is electrically coupled to head module 12. The rotation of head module 12 onto male end 36 electrically couples head module 12 to body module 16 when the first housing portion 11 of head module 12 and the second housing portion 13 of body module 16 comprises a conductive material. Body module 16 is electrically coupled to the negative end of the series of batteries 40 by pin 46, which resides therebetween. However, since no contact is made between the male end of the series of batteries 40 and light source 24, as illustrated at spring 42, the light source 24 is deactuated and does not provide illumination therefrom. While the illustrated embodiment provides spring 42 mounted to light source 24, those of skill in the art will appreciate that spring 42 may be oriented in a variety of different manners, such as, for example, mounted to the positive end of battery 40a.

Alternatively, in FIG. 4B a schematic representation is provided of a closed circuit that actuates light source 24 so as to provide, with the assistance of reflector 22, a direct beam of light through lens 20. As illustrated in FIG. 4B, light source 24 is electrically connected to a conductive plate 44, which is electrically coupled to head module 12. The rotation of head module 12 onto male end 36 electrically couples head module 12 to body module 16 when the housing of head module 12 and the housing of body module 16 comprises a conductive material, such as metal. Body module 16 is electrically coupled to the negative end of the series of batteries 40 by pin 46, which resides therebetween. However, in contrast to FIG. 4A, the circuit in FIG. 4B is closed since an electrical contact is made between the male end of the series of batteries 40 and light source 24. The contact is made by spring 42, which is interposed between the male end of the series of batteries 40 and light source 24 when the coupling of head module 12 and body module 16 push bracket system 14 together to cause spring 42 to electrically couple light source 24 with the positive end of the series of batteries 40. With the electrical circuit being closed, the light source is actuated and provides illumination that is focused as a beam of light through lens 20.

FIGS. 4A and 4B further illustrate an example of a flashlight housing configured to receive a bracket thereon. The flashlight housing comprises a hollow member such as body module 16 that includes a coupling portion 47 (e.g., threads) a first exterior surface 48 and a second exterior surface 50 that is raised with respect to the first exterior surface 48. The flashlight housing further comprises another hollow member, such as head module 12, that includes a coupling portion 52 (e.g., threads) which is configured to couple to coupling portion 47, and an exterior surface 54 that is raised with respect to exterior surface 48. While coupling portions 47 and 52 are threadedly coupled, other manners of coupling may be employed such as clip fitting parts, snap fitting parts, friction fitting parts, and other connection parts.

Therefore, a bracket system, such as bracket system 14 of FIG. 1 may be placed on the exterior surface 48 and the coupling of head module 12 to body module 16 couples the bracket system 14 of FIG. 1 to a support member, such as handlebar 32 of FIG. 2. As shown by coupling rings 15a and 15b between surfaces 50 and 54, bracket system 14 can be coupled to a support member.

Thus, the present invention relates to an attachable illumination device that is selectively and removably coupled to a support member of, for example, a non-motorized recreational vehicle or other structure. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by United States Letters Patent is:

1. A bracket system for selectively and removably coupling a flashlight to a support member, the bracket system comprising
a coupling portion; and
a gripping portion extending from the coupling portion, wherein the bracket system is configured such that the coupling of a flashlight housing to the coupling portion couples the gripping portion to the support member.

2. A bracket system as recited in claim 1, wherein the coupling portion comprises first and second cylindrical coupling rings and the gripping portion comprises first and second gripping fingers extending from the first and second cylindrical coupling rings, respectively.

3. A bracket system as recited in claim 1, wherein the flashlight housing comprises a first portion and a second portion, and wherein the coupling portion of the bracket system is positioned between a surface portion of the first housing portion and a surface of the second housing portion.

4. A bracket system as recited in claim 3, wherein the first and second portions of the flashlight housing are threadedly coupled to thereby couple the bracket to the support member.

5. A bracket system for selectively coupling a flashlight to a support member, the system comprising:
a first coupling ring configured to receive a portion of a flashlight housing therethrough;
a first gripping finger extending from the first coupling ring;
a second coupling ring configured to receive a portion of a flashlight housing therethrough; and
a second gripping finger extending from the second coupling ring, such that placement of the first coupling ring adjacent the second coupling ring places the first gripping finger adjacent the second gripping finger.

6. A bracket system as recited in claim 5, wherein the coupling of the flashlight housing to the first and second coupling rings couples the first and second gripping fingers to a support member.

7. A bracket system as recited in claim 6, wherein the flashlight housing comprises a first portion and a second portion, wherein the first portion houses a light source and the second portion houses a power source.

8. A bracket system as recited in claim 7, wherein the first and second coupling rings are positioned between a surface of the first and second portions of the flashlight housing to couple the housing to the first and second coupling rings.

9. A bracket system as recited in claim 8, wherein the first and second portions of the flashlight housing are threadedly coupled.

10. A bracket system as recited in claim 1, wherein the flashlight housing comprises a conductive material.

11. A mountable flashlight housing and bracket system comprising:
a flashlight housing; and
a bracket system configured to receive a portion of a support member and a portion of the flashlight housing, wherein the mounting of the flashlight housing onto the bracket system secures the bracket system onto the support member.

12. A mountable flashlight housing and bracket system as recited in claim 11, wherein the flashlight housing comprises a first module and a second module, and wherein the first and second modules are selectively coupled.

13. A mountable flashlight housing and bracket system as recited in claim 12, wherein a portion of the bracket system is coupled about a male end of the second module, and wherein the male end of the second module is selectively coupled to a female end of the first module.

14. A mountable flashlight housing and bracket system as recited in claim 13, wherein the male and female ends are threadedly coupled.

15. A mountable flashlight housing and bracket system as recited in claim 14, wherein the bracket system comprises:
a first bracket portion having a first gripping finger; and
a second bracket portion having a second gripping finger, wherein a combination of the first and second gripping fingers receive the portion of the support member.

16. A mountable flashlight housing and bracket system as recited in claim 15, further comprising a grip on the flashlight housing, wherein the grip facilitates a user in coupling and decoupling the female end to the male end.

17. A mountable flashlight housing and bracket system as recited in claim 16, wherein the flashlight housing is configured to house a light source and a power source.

18. A mountable flashlight system as recited in claim 17, wherein the light source comprises at least one of:
(i) a bulb; and
(ii) a light emitting diode.

19. A mountable flashlight system as recited in claim 18, wherein the power source comprises a portable battery.

20. A mountable flashlight system that is selectively and removably coupled to a support member, the system comprising:
a flashlight comprising:
a housing having a first portion and a second portion;
a light source housed by the housing; and
a power source housed by the housing; and
a bracket, wherein a portion of the bracket is positioned between a surface of the first housing portion and a surface of the second housing portion.

21. A mountable flashlight system as recited in claim 20, wherein the light source comprises at least one of:
(i) a bulb; and
(ii) a light emitting diode.

22. A mountable flashlight system as recited in claim 21, wherein the flashlight further comprises a reflector and a lens.

23. A mountable flashlight system as recited in claim 22, wherein the reflector is a parabolic reflector to concentrate the illumination from the light source into a beam of light that is emitted through the lens.

24. A mountable flashlight system as recited in claim 23, wherein the lens is a polycarbonate lens.

25. A mountable flashlight system as recited in claim 22, wherein the first portion of the housing comprises a female end that is threadedly coupled to a male end of the second portion of the housing.

26. A mountable flashlight system as recited in claim 25, wherein the female end is threadedly coupled to the male end to secure the bracket system to a support member.

27. A mountable flashlight housing and bracket kit comprising:
a flashlight housing having a first portion and a second portion, wherein the flashlight housing is configured to house a light source and a power source; and
a bracket system configured to be mounted on a support member when the first and second portions of the flashlight housing are coupled together.

28. A mountable flashlight housing and bracket kit as recited in claim 27, wherein the light source comprises at least one of:
(i) a bulb; and
(ii) a light emitting diode.

29. A mountable flashlight housing and bracket kit as recited in claim 27, wherein the power source comprises a portable battery.

30. A mountable flashlight housing and bracket kit as recited in claim 27, wherein the housing comprises a conductive material.

31. A mountable flashlight housing and bracket kit as recited in claim 27, wherein the bracket system comprises a non-conductive material.

32. A flashlight housing configured to receive a bracket thereon, comprising:
a first flashlight housing portion comprising a hollow member, the hollow member having a coupling portion, a first exterior surface, and a second exterior surface, wherein the second exterior surface is raised with respect to the first exterior surface; and
a second flashlight housing portion comprising a hollow member, the hollow member having a coupling portion that is configured to couple to the coupling portion of the first flashlight housing, the second flashlight housing portion having an exterior surface that is raised with respect to the first exterior surface of the first housing portion.

33. A flashlight housing as recited in claim 32, wherein the coupling portion of the first flashlight portion and the coupling portion of the second flashlight portion are mating threads that threadedly couple the first and second flashlight portions.

34. A flashlight housing as recited in claim 33, wherein a bracket may be placed on the first exterior surface of the first housing portion such that the bracket rests between the second exterior surface and the second flashlight housing portion.
